(19) United States
(12) Patent Application Publication
(10) Pub. No.: US 2013/0312333 A1
(43) Pub. Date: Nov. 28, 2013

(54) HORIZONTAL SLIDING WALL STRUCTURE

(71) Applicant: Shou-Hsing LIAO, Taichung City (TW)

(72) Inventor: Shou-Hsing LIAO, Taichung City (TW)

(21) Appl. No.: 13/478,431

(22) Filed: May 23, 2012

(51) Int. Cl. E06B 3/46

(52) U.S. Cl. 49/425

(57) ABSTRACT

A horizontal sliding wall structure is located in a rail which has a housing space and a sliding slot communicating with the housing space. The horizontal sliding wall structure includes a sliding door panel, a horizontal sliding assembly located in the housing space and a suspension rod connecting to the sliding door panel and horizontal sliding assembly. The horizontal sliding assembly includes a main body, four bottom roller sets, four lateral roller sets perpendicular to the bottom roller sets, a suspension hole and an upper lid. The upper lid and suspension hole form a concealed space therebetween. The suspension rod has a support end held in the concealed space and a connection end running through the sliding slot to connect to the sliding door panel. The upper lid can prevent dust and dirt from accumulating and also prohibit the suspension rod from moving vertically.

### FIELD OF THE INVENTION

The present invention relates to a wall structure and particularly to a horizontal sliding wall structure.

### BACKGROUND OF THE INVENTION

In conventional building design, a partition wall structure usually includes a rail installed on the ceiling, a suspension structure slidable horizontally in the rail and a partition panel connected to the suspension structure. For instance, U.S. Pat. No. 4,555,828 entitled “Guiding system for movable suspended partition walls”, referring to FIGS. 1A and 1B, includes a suspension rod 6 running through a main body 4 and latched thereon via a support portion 7 to allow users to easily move a partition wall 3 upwards so that the bolt (not shown in the drawings) fastened to the partition wall 3 can be moved away from the floor and slid horizontally. The partition wall 3 tends to tilt about the suspension rod and forms a gap with a neighboring partition wall 3. As a result, people can pass through the gap of the partition wall 3, and the intended security and burglarproof function by dividing the two spaces is tampered. Moreover, the suspension rod 6 does not have dust guarding means, and dust and dirt easily accumulate on the support portion 7 and results in clogging on the coupling portion of the suspension rod 6 and main body 4 and causes troubles when in use.

### SUMMARY OF THE INVENTION

The primary object of the present invention is to solve the problem of the suspension rod in the conventional technique that freely moves upward to causes failure of the intended burglarproof function.

Another object of the invention is to resolve the problem of dust and dirt accumulation between the main body and suspension rod occurred to the conventional technique.

To achieve the foregoing objects, the invention provides a horizontal sliding wall structure which is located in a rail. The rail has a housing space and a sliding slot communicating with the housing space. The horizontal sliding wall structure comprises a sliding door panel, a horizontal sliding assembly held in the housing space and a suspension rod connecting to the sliding door panel and horizontal sliding assembly. The sliding door panel is located at one side of the rail adjacent to the sliding slot. The horizontal sliding assembly includes a main body, four symmetrical bottom roller sets coupled on the main body to prevent the horizontal sliding assembly from wobbling vertically, four lateral roller sets perpendicular to the bottom roller sets to prevent the horizontal sliding assembly from wobbling horizontally, a suspension hole running through the main body and corresponding to the sliding slot, and an upper lid located at one side of the main body remote from the sliding slot. The upper lid and the suspension hole form a concealed space between them. The suspension rod runs through the suspension hole and is extended outside the sliding slot, and has a support end held in the concealed space to prevent the suspension rod from moving vertically and a connection end passed through the sliding slot to connect to the sliding door panel.

By means of the construction set forth above, the upper lid can prevent dust and dirt from entering via the suspension hole to accumulate on the suspension rod and suspension hole, and also prohibit the suspension rod from moving vertically, therefore the fastening bolt on the sliding door panel can be prevented from moving away from the floor while the sliding door panel is pushed without tilting to create a gap between the neighboring sliding door panels that could allow people to pass through, thereby the burglarproof function is achieved.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1A is a sectional view of a conventional technique.

FIG. 1B is a schematic view of a conventional technique in a use condition.

FIG. 2 is a schematic view of the invention in an assembly condition.

FIG. 3 is an exploded view of the invention.

FIG. 4 is a top view of the invention.

FIG. 5 is a side view of the invention.

FIG. 6 is another sectional view of the invention.

FIGS. 7A through 7C are schematic views showing the invention moving on a branch rail in use conditions.

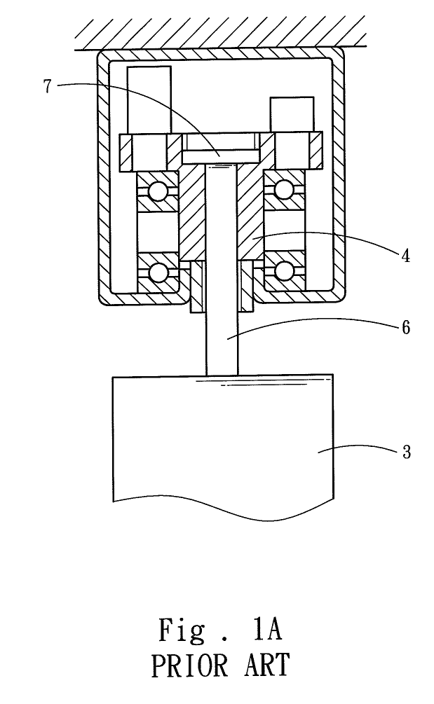

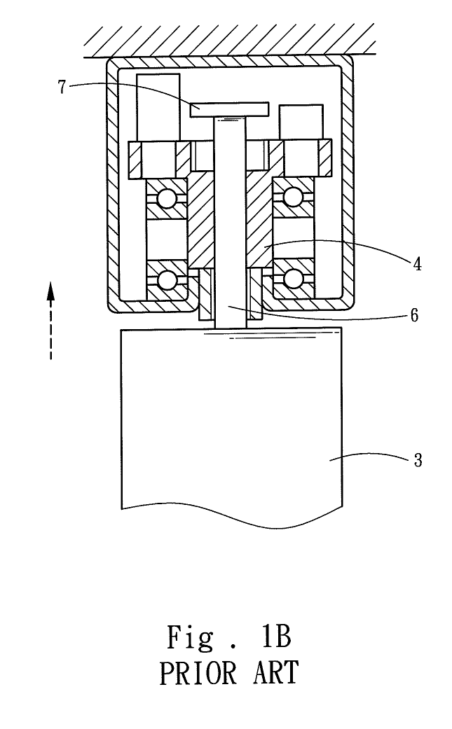

### DETAILED DESCRIPTION OF THE PREFERRED EMBODIMENTS

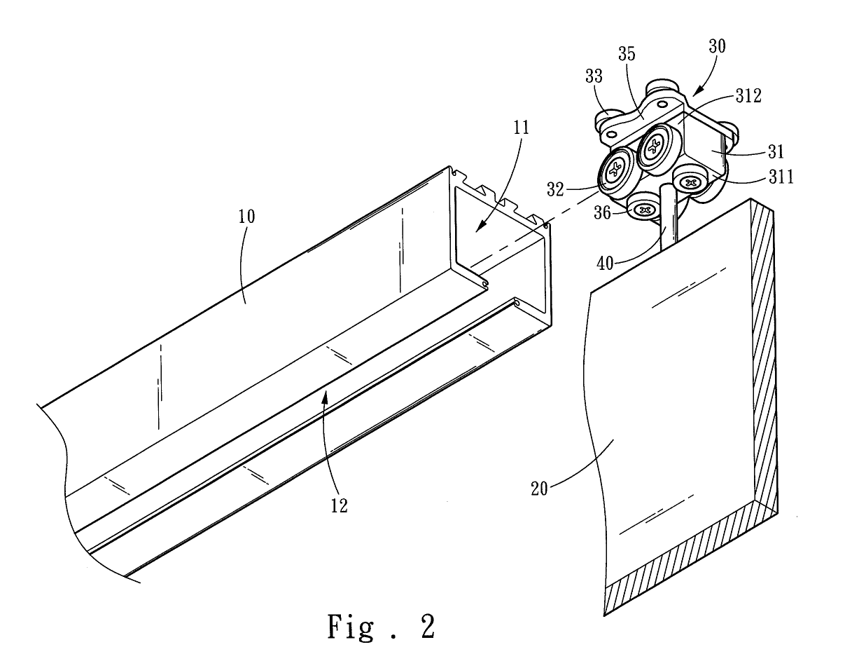

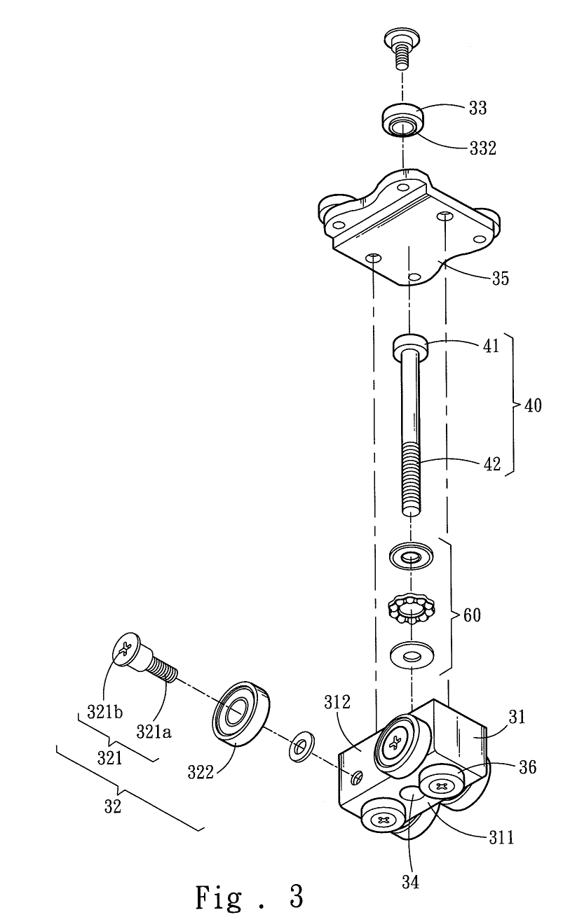

Please refer to FIGS. 2 and 3, the present invention aims to provide a horizontal sliding wall structure. It is located in a rail 10 which has a housing space 11 and a sliding slot 12 communicating with the housing space 11. The horizontal sliding wall structure according to the invention comprises a sliding door panel 20, a horizontal sliding assembly 30 located in the housing space 11 and a suspension rod 40 connecting to the sliding door panel 20 and horizontal sliding assembly 30. The sliding door panel 20 is located at one side of the rail 10 adjacent to the sliding slot 12. The horizontal sliding assembly 30 includes a main body 31, four symmetrical bottom roller sets 32 coupled on the main body 31, four lateral roller sets 33 perpendicular to the bottom roller sets 32, a suspension hole 34 running through the main body 31 and corresponding to the sliding slot 12, and an upper lid 35 located at one side of the main body 31 remote from the sliding slot 12.

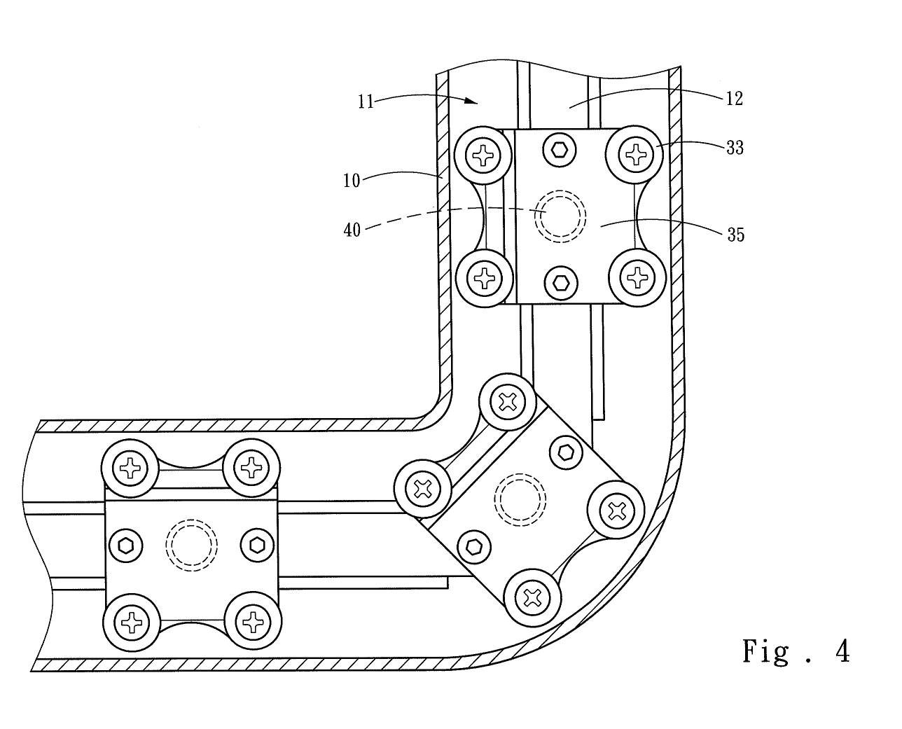

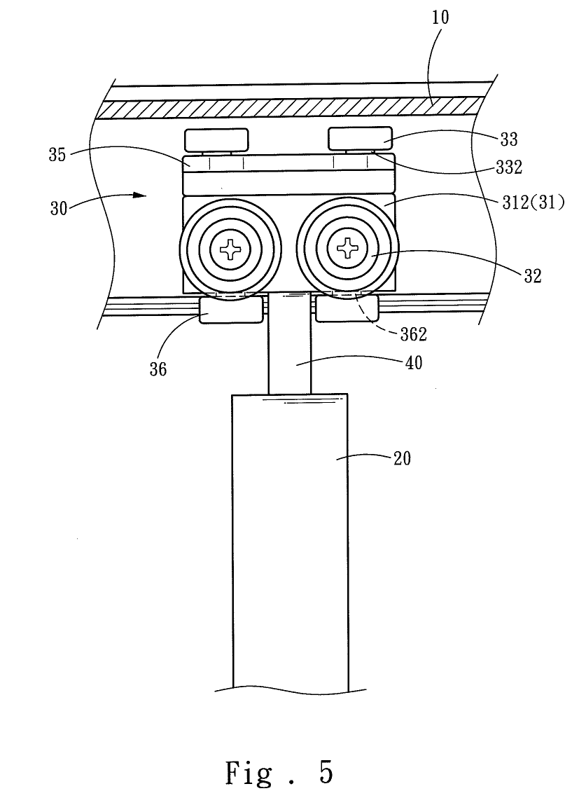

The main body 31 has a bottom surface 311 abutting the sliding slot 12 and two lateral surfaces 312 perpendicular to the bottom surface 311. Referring to FIGS. 4 and 5, the four bottom roller sets 32 are located in pairs on the lateral surfaces 312 opposite to each other to contact and roll on one side of the rail 10 where the sliding slot 12 is formed. Each of the bottom roller sets 32 has a bottom pin 321 and a bottom roller 322 coupled on the bottom pin 321. The bottom pin 321 also has a fastening portion 321a fastened to the main body 31 and an operating portion 321b remote from the main body 31. The operating portion 321b is wrenched by a screw driver to fasten the bottom pin 321 to the main body 31 or unfasten the bottom pin 321 from the main body 31.

The four lateral roller sets 33 are located on the upper lid 35 remote from the lateral surfaces 312 of the main body 31 to contact and roll on other sides of the rail 10 abutting the sliding slot 12. Each of the lateral roller sets 33 has a first protrusive pad 332 abutting the main body 31 that is in contact with the main body 31 through a smaller area to reduce frictional force. The bottom surface 311 also has at least one ancillary roller set 36 mounted thereon corresponding to the sliding slot 12. The ancillary roller set 36 has a second protrusive pad 362 abutting and in contact with the main body 31 through a smaller area to reduce frictional force and facilitate horizontal sliding, thereby the frictional force between the horizontal sliding assembly 30 and rail 10 can be reduced.

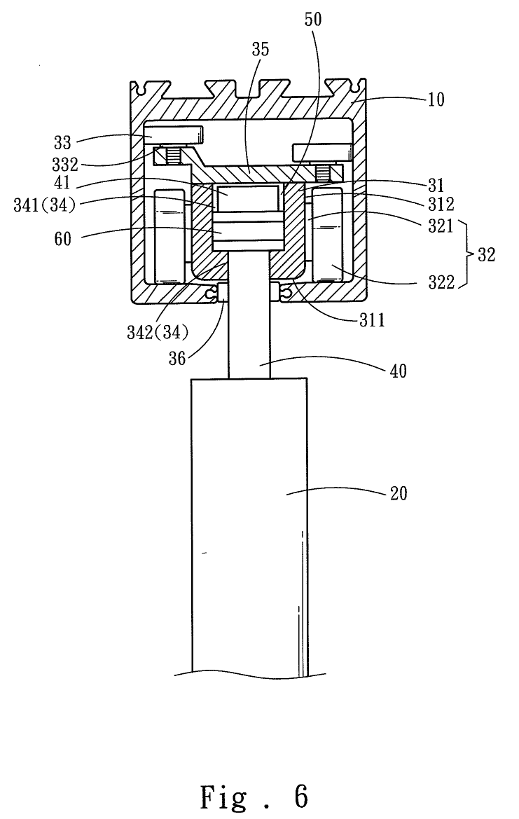

Also referring to FIG. 6, the upper lid 35 and suspension hole 34 form a concealed space 50 between them. The suspension rod 40 runs through the suspension hole 34 and is extended outside the sliding slot 12, and also has a support end 41 held in the concealed space 50 and a connection end 42 passing through the sliding slot 12 to connect to the sliding door panel 20. More specifically, the suspension hole 34 includes a first aperture 341 abutting the upper lid 35 and a second aperture 342 remote from the upper lid 35. The first aperture 341 is formed at a diameter greater than that of the second aperture 342 to match the support end 41. In addition, the support end 41 and first aperture 341 are interposed by a thrust bearing 60 perpendicular to the axis of the suspension rod 40 to reduce the gravity of the sliding door panel 20 to facilitate pushing thereof.

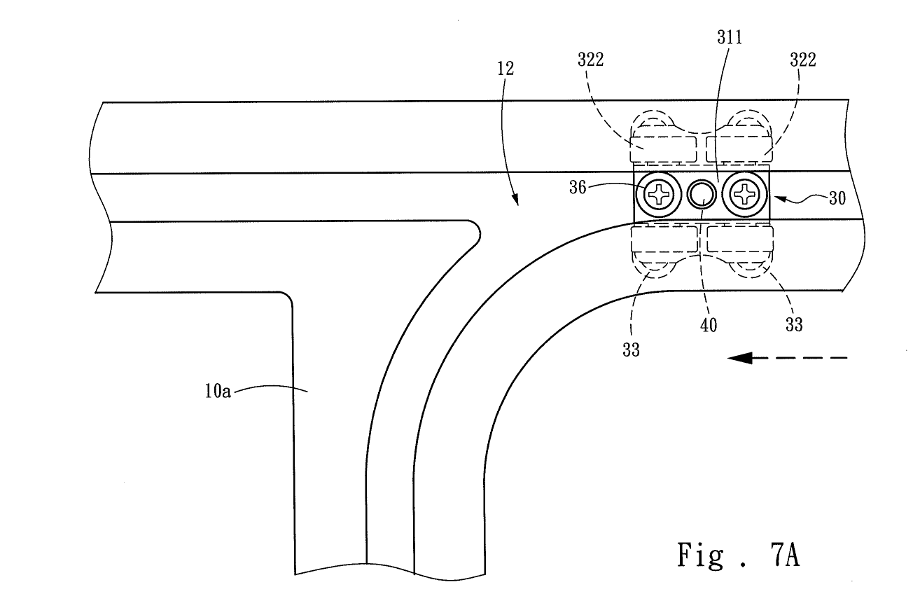

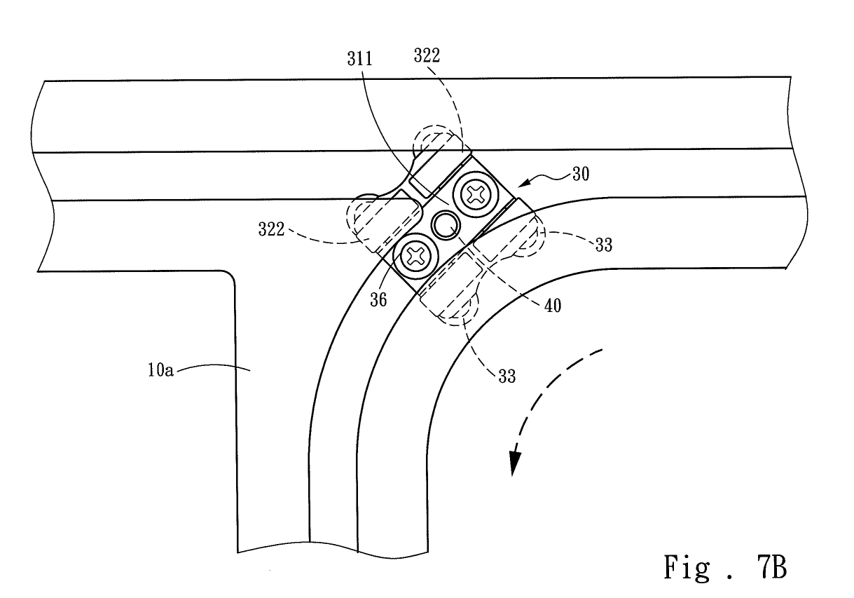

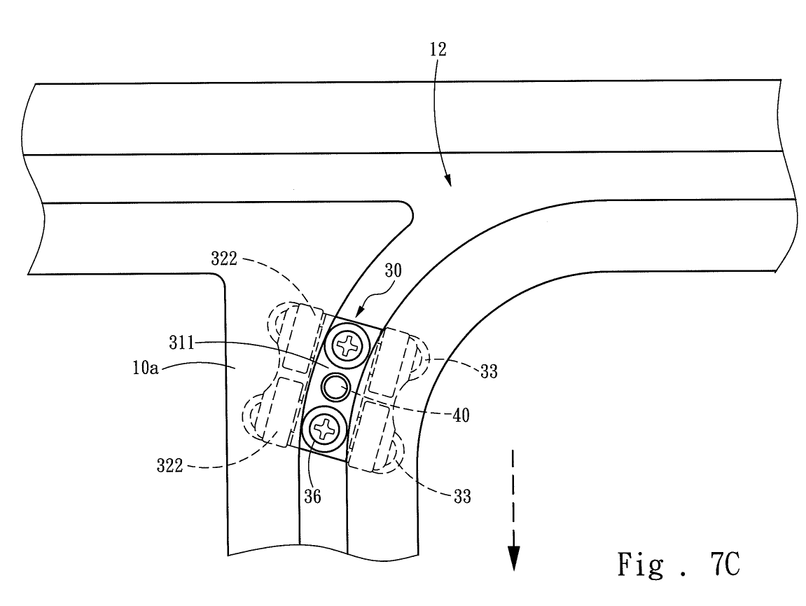

Please refer to FIGS. 7A through 7C, in the event that a branch rail 10a is provided, the sliding wall of the invention can also be moved thereon. Referring to FIG. 7B, the branch rail 10a has a slide slot 12a in the middle formed at a larger size. When the two bottom roller sets 32 are straddled the branch rail 12a, at least three bottom rollers 322 can be in contact with the two ends of the branch rail 10a, thereby improved steadiness is achieved.

As a conclusion, compared with the conventional technique, the invention provides features as follows:

1. Through the upper lid dust and dirt cannot enter through the suspension hole to accumulate on the suspension rod and suspension hole.

2. The upper lid prohibits the suspension rod from moving vertically, thus the fastening bolt on the sliding door panel can be prevented from moving away from the floor while the sliding door panel is pushed without tilting to create a gap between the neighboring sliding door panels that could allow people to pass through, thereby the burglarproof function is achieved.

3. The symmetrical four bottom roller sets can prevent the main body from wobbling vertically, and the four lateral roller sets can also prevent the main body from wobbling horizontally, thereby stability during horizontal sliding of the horizontal sliding assembly is improved.

What is claimed is:

1. A horizontal sliding wall structure located in a rail which includes a housing space and a sliding slot communicating with the housing space, comprising:
a sliding door panel located at one side of the rail abutting the sliding slot;
a horizontal sliding assembly which is located in the housing space and includes a main body, four symmetrical bottom roller sets coupled on the main body to prevent vertical wobbling of the horizontal sliding assembly, four lateral roller sets coupled on the main body and perpendicular to the four bottom roller sets to prevent horizontal wobbling of the horizontal sliding assembly, a suspension hole running through the main body and corresponding to the sliding slot, and an upper lid located at one side of the main body remote from the sliding slot; the four bottom roller sets contacting and rolling on one side of the rail where the sliding slot is formed, the four lateral roller sets contacting and rolling on other sides of the rail abutting the sliding slot, the upper lid and the suspension hole forming a concealed space therebetween; and
a suspension rod which is connected to the sliding door panel and the horizontal sliding assembly, and runs through the suspension hole to extend outside the sliding slot, and includes a support end held in the concealed space to prevent the suspension rod from moving vertically and a connection end passing through the sliding slot to connect to the sliding door panel.

2. The horizontal sliding wall structure of claim 1, wherein the main body includes a bottom surface abutting the sliding slot and two lateral surfaces perpendicular to the bottom surface, the four bottom roller sets being located in pairs on the two lateral surfaces opposite to each other.

3. The horizontal sliding wall structure of claim 1, wherein each of the four bottom roller sets includes a bottom pin and a bottom roller coupled on the bottom pin, the bottom pin including a fastening portion fastened to the main body and an operating portion remote from the main body.

4. The horizontal sliding wall structure of claim 1, wherein the four lateral roller sets are located on the upper lid remote from one lateral surface of the main body.

5. The horizontal sliding wall structure of claim 1, wherein main body includes a bottom surface abutting the sliding slot, the bottom surface of the main body holding at least one ancillary roller set corresponding to the sliding slot.

6. The horizontal sliding wall structure of claim 5, wherein the at least one ancillary roller set and the four lateral roller sets include respectively a protrusive pad abutting the main body.

7. The horizontal sliding wall structure of claim 1, wherein the suspension hole includes a first aperture abutting the upper lid and a second aperture remote from the upper lid, the first aperture being formed at a diameter greater than that of the second aperture to mate the support end.

8. The horizontal sliding wall structure of claim 7, wherein the support end and the first aperture are interposed by a thrust bearing perpendicular to an axis of the suspension rod.
